(19) United States
(12) Patent Application Publication
(10) Pub. No.: US 2019/0220096 A1
(43) Pub. Date: Jul. 18, 2019

(54) SYSTEM AND METHOD FOR NATURAL CONTENT EDITING WITH GESTURES

(71) Applicant: Microsoft Technology Licensing, LLC, Redmond, WA (US)

(72) Inventors: Xiao Tu, Medina, WA (US); Sheng Yi, Bellevue, WA (US); Yibo Sun, Bellevue, WA (US); Zhe Wang, Redmond, WA (US); Kyle T. Beck, Redmond, WA (US)

(21) Appl. No.: 15/873,546

(22) Filed: Jan. 17, 2018

(51) Int. Cl. G06F 3/01; G06K 9/00; G06F 17/24

(52) U.S. Cl. CPC G06F 3/017; G06K 9/00335; G06K 9/00402; G06F 17/242; G06F 17/241

(57) ABSTRACT

Methods, systems, and apparatuses for natural content editing with gestures include a gesture recognition engine with an input component that receives first information concerning content rendered to a user interface and second information concerning a user gesture applied to the user interface. A context-free gesture recognizer obtains shape features based on the second information and generates a context-free gesture hypothesis for the user gesture based on the shape features. A context-aware gesture recognizer obtains contextual features based on the first information and the second information and evaluates the context-free gesture hypothesis based on the contextual features to make a final gesture decision for the user gesture. An output component outputs the final gesture decision for the user gesture to the application. An application programming interface enables an application to invoke the gesture recognition engine and allows for customized gesture configuration and recognition.

### BACKGROUND

Many computer-aided drawing programs allow users to draw on a digital canvas in a convenient freeform manner that displays the raw drawing strokes input by the user on the digital drawing canvas. When editing on physical paper, it is common practice to take a physical pen and mark the paper up by crossing out erroneous words, creating emphasis by underlining items, splitting and joining words, overwriting words, etc. In addition, it is common when writing notes to do similar editing types of actions, as well as things like drawing arrows or lines to connect two related pieces of content. These drawing actions allow users to both quickly review and edit documents, as well as express their thoughts in a truly personal manner. Digital pens which produce images with digital ink allow for content creation on a digital canvas such as a computer screen in a very natural manner like the use of a traditional pen. However, like when paper is used, users often want to annotate and change the content created either because it was later recognized as wrong, they changed their mind, or they made a mistake. For a computer program to implement a change or annotation indicated by a user's drawing strokes, the computer program must first be able to recognize the input drawing stroke as indicating a desire on the part of the user to perform a particular editing action.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and apparatuses for natural content editing with gestures include a gesture recognition engine with an input component that receives first information concerning content rendered to a user interface (UI) (e.g., by an application) and second information concerning a user gesture applied to the UI. A context-free gesture recognizer obtains shape features based on the second information and generates a context-free gesture hypothesis for the user gesture based on the shape features. A context-aware gesture recognizer obtains contextual features based on the first information and the second information and evaluates the context-free gesture hypothesis based on the contextual features to make a final gesture decision for the user gesture. An output component outputs the final gesture decision for the user gesture. An application programming interface (API) may be provided that enables an application to invoke the gesture recognition engine to recognize a gesture based on the first information and the second information. The API may allow for customized gesture configuration and recognition.

Further features and advantages of the systems and methods, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present methods and systems and, together with the description, further serve to explain the principles of the methods and systems and to enable a person skilled in the pertinent art to make and use the methods and systems.

FIG. 1 is a block diagram of a gesture recognition engine in accordance with an embodiment.

FIG. 2 shows a flowchart of a method of generating a gesture type decision in accordance with an embodiment.

FIG. 3 is a block diagram of a gesture recognition engine in accordance with another embodiment.

FIG. 4 shows a flowchart of a method of generating a gesture type decision in accordance with another embodiment.

FIG. 5 is an example of an abstracted view of non-gesture content that may be rendered to a UI in accordance with an embodiment.

FIG. 6 is a block diagram of a gesture recognition engine in accordance with a further embodiment.

FIGS. 7A and 7B are illustrations of a strike-through gesture on non-gesture writing and a strike-through gesture on gesture writing, respectively, that may be recognized by a gesture recognition engine in accordance with an embodiment.

FIGS. 8A and 8B are illustrations of a scratch-out gesture on non-gesture writing and a scratch-out gesture on gesture writing, respectively, that may be recognized by a gesture recognition engine in accordance with an embodiment.

FIGS. 9A and 9B are illustrations of a split within a word gesture on non-gesture writing and a split within a word gesture on gesture writing, respectively, that may be recognized by a gesture recognition engine in accordance with an embodiment.

FIGS. 10A and 10B are illustrations of a join gesture on non-gesture writing and a join gesture on gesture writing, respectively, that may be recognized by a gesture recognition engine in accordance with an embodiment.

FIG. 11 is an illustration of a connect gesture that may be recognized by a gesture recognition engine in accordance with an embodiment.

FIG. 12 is an illustration of a directional connect gesture that may be recognized by a gesture recognition engine in accordance with an embodiment.

FIG. 13 is an illustration of an overwrite gesture on non-gesture content that may be recognized by a gesture recognition engine in accordance with an embodiment.

FIG. 14 is an illustration of an insertion between words gesture on non-gesture content that may be recognized by a gesture recognition engine in accordance with an embodiment.

FIG. 15 is an illustration of a commit or new line gesture on non-gesture content that may be recognized by a gesture recognition engine in accordance with an embodiment.

FIG. 16 is a block diagram of a system for gesture recognition in accordance with an embodiment.

FIG. 17 is a block diagram of a system for gesture recognition in accordance with another embodiment.

FIG. 18 is an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Introduction

The present specification and accompanying drawings disclose one or more embodiments that incorporate the features of the present methods and systems. The scope of the present methods and systems is not limited to the disclosed embodiments. The disclosed embodiments merely exemplify the present methods and systems, and modified versions of the disclosed embodiments are also encompassed by the present methods and systems. Embodiments of the present methods and systems are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

The example embodiments described herein are provided for illustrative purposes, and are not limiting. The examples described herein may be adapted to any type of gesture recognition system or configuration. Further structural and operational embodiments, including modifications/alterations, will become apparent to persons skilled in the relevant art(s) from the teachings herein.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### Example Embodiments

Methods and systems described herein relate to the automatic recognition of gesture content that is rendered to a user interface (UI), wherein the gesture content is rendered on or close to other content (e.g., other non-gesture content previously rendered to the user interface by an application), and wherein the gesture content is recognized as a particular type of gesture or annotation. A gesture recognition system in accordance with an embodiment leverages both non-contextual features associated with the gesture content (e.g., shape features) and contextual features associated with the relationship between the gesture content and the other previously-rendered content to provide a more accurate classification of the content.

To recognize a gesture, a gesture recognition engine in accordance with an embodiment utilizes contextual features that represent relationships between the gesture and other objects on the screen on which the gesture has been drawn. When a user enters gesture-based annotations on top of gesture content that has already been entered by a user, a gesture recognizer may be inherently capable of recognizing the various gestures if it includes a classifier that recognizes and categorizes of the all gesture content (e.g., strokes, ink) on the screen. However, when a user enters gesture-based annotations on top of non-gesture objects such as application-rendered text, the gesture recognizer will have no inherent knowledge regarding the non-gesture objects. To support these annotation scenarios, embodiments of a gesture recognition engine described herein are operable to receive information from an application about non-gesture objects so that the gesture recognition engine can take this information into account when performing gesture or annotation recognition. For example, an application that utilizes the gesture recognition engine can pass any of the following information about non-gesture content to the gesture recognition engine: a bounding box, a node type, and, for text content, a word bounding rectangle, a character bounding rectangle, a textual baseline, a spacing between characters, a line height, an ascent, a descent, a line gap, an advancement, an x-height, a cap height, an italic angle, a font-type, and a font-specific characteristic. Information about a variety of different node types may be provided by the application including but not limited to text, gesture content (e.g., strokes, ink), pictures, shapes, mathematical symbols, and musical symbols.

A gesture recognition engine in accordance with an embodiment is therefore capable of utilizing contextual features to detect users' intentions regarding whether they want to change previously-rendered content by overwriting the previously-rendered content, adding to the previously-rendered content, using gestures to delete some or all previously-rendered content or inserting new content. A gesture recognition engine in accordance with an embodiment allows these types of actions to be taken with a digital pen, stylus, finger, or other gesture-creating tool and allows such actions to be applied to various types of gesture and non-gesture content, thereby providing for fluid and powerful gesture-based annotation of content.

Embodiments described herein are further directed to systems and methods for recognizing gesture content that is rendered to a UI on or close to other content that was previously rendered to the UI, such as application-rendered text or other gesture or non-gesture content. A gesture recognition engine in accordance with an embodiment leverages an abstracted view of the content that may comprise information such as a bounding box, a textual base line, a spacing between characters, a line height, or the like, to make a more accurate classification of any gestures that may be present. The natural interactions supported by a gesture recognition engine in accordance with an embodiment include writing or drawing over content to change the content. Examples of such interactions include, but are not limited to, writing the letter “t” over the letter “r” to change a word from “Parent” to “Patent”, writing over a math symbol to change it from x² to x³, and drawing over geometric shapes to change their angles or connect two lines. In addition, a gesture recognition engine in accordance with an embodiment can recognize gestures such as a chevron gesture to insert, a scratch-out or strike-through gesture to delete, a down-left gesture to add a new line, and a curve gesture to join two words or letters. A gesture recognition engine in accordance with an embodiment can also recognize any combination of these gestures. For instance, a chevron gesture and a new handwritten word can both be recognized together to perform an insertion of the word.

By leveraging certain non-contextual features (e.g., shape features) and contextual features, a gesture recognition engine as described herein can recognize editing or annotation gestures without requiring a user to perform a mode switching operation that indicates that the user has entered an editing mode.

A gesture recognition engine in accordance with an embodiment can also be used to change the attributes of non-gesture content. For instance, a double line gesture under a textual baseline of a word can be recognized and used to bold the word. Different gestures or annotations can be also be recognized by the gesture recognition engine that cause a word to be rendered in italic or that cause an area to be filled with a certain color. The gesture recognition engine can be configured to recognize certain custom-defined gestures such as interpreting drawing double lines together as an instruction to make a space wider.

FIG. 1 is a block diagram of a gesture recognition engine 100 in accordance with an embodiment. As shown in FIG. 1, gesture recognition engine 100 includes an input component 102, a context-aware gesture recognizer 104 and an output component 106. Each of these components may be implemented in software (e.g., as program logic executed by one or more processors), in hardware (as one or more digital and/or analog circuits), or as a combination of software and hardware.

Input component 102 is configured to receive first information concerning content rendered to a UI and second information concerning a user gesture applied to the UI. The first information and/or the second information may be provided to input component 102 by an application that invokes gesture recognition engine 100. The first information may comprise, for example, information about non-gesture content (e.g., text) rendered to the UI by an application, although this example is not intended to be limiting. The first information may be information about text content, shape content, picture content, mathematical symbol content, musical symbol content, or any other content rendered to the UI. By way of further example, the first information may include a bounding box, a node type such as text, picture or shape, and, for text content, a textual baseline, a word or character bounding rectangle, a spacing between characters, a line height, an ascent, a descent, a line gap, an advancement, an x-height, a cap height, an italic angle, a font-type, a font-specific characteristic, etc. The first image may also comprise an image that includes the content rendered to the UI.

The second information may comprise information about a user gesture (e.g., one or more drawing strokes) entered by a user of the application on or near the previously-rendered content. For example, an application may allow a user to enter free-form sketches with a digital pen, stylus, finger, or other gesture-creating tool. The user's free-form sketches on the UI may represent specific types of gestures or annotations that indicate the user's desire to annotate other content displayed on a drawing canvas such as a touchscreen. As the user moves the gesture-creating tool, a digitizer may report information about the tool's movement that may include an array of data points that each contain information such as an x and y position, a pressure value, a tilt angle of the tool, timestamp information, etc. This information may be provided as the second information to input component 102.

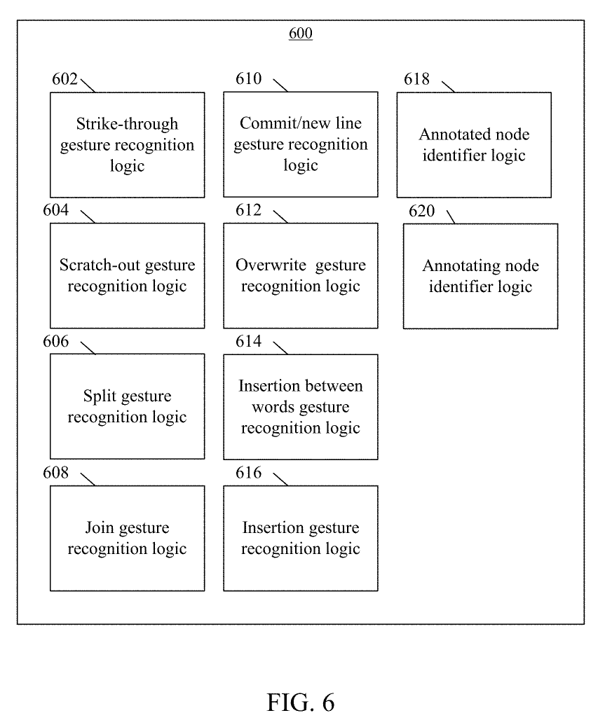

Context-aware gesture recognizer 104 is configured to obtain contextual features based on the first information and the second information and identify a gesture type for the user gesture from among a plurality of gesture types based on the contextual features. As noted above, the first information may comprise an abstracted view of non-gesture content and may include information such as a bounding box, a textual base line, a spacing between characters, a line height, or the like. As discussed in more detail below with respect to FIG. 6, the first information may include a variety of additional parameters regarding non-gesture content. The second information may comprise information about the user gesture (e.g., stroke information). Context-aware gesture recognizer 104 is configured to detect a gesture type by determining and considering contextual features that describe how the content rendered to the UI and the user gesture applied to the UI are interrelated, wherein such contextual features are obtained based on the first and second information. By considering such contextual features, context-aware gesture recognizer 104 can detect annotations of content that would otherwise be undetectable or and/or can detect annotations of content more reliably. Context-aware gesture recognizer 104 may be implemented using a decision tree recognizer, a heuristic recognizer, or a neural network recognizer, although these are examples only and are not intended to be limiting.

Output component 106 outputs the identified gesture type for the user gesture. For example, output component 106 may output the identified gesture type to an application that invoked gesture recognition engine 100. The gesture type may represent a type of annotation or gesture that gesture recognition engine 100 determines has been applied by a user to the UI. In an embodiment, input component 102 and output component 106 comprise part of an API that can be used by an application to invoke gesture recognition engine 100.

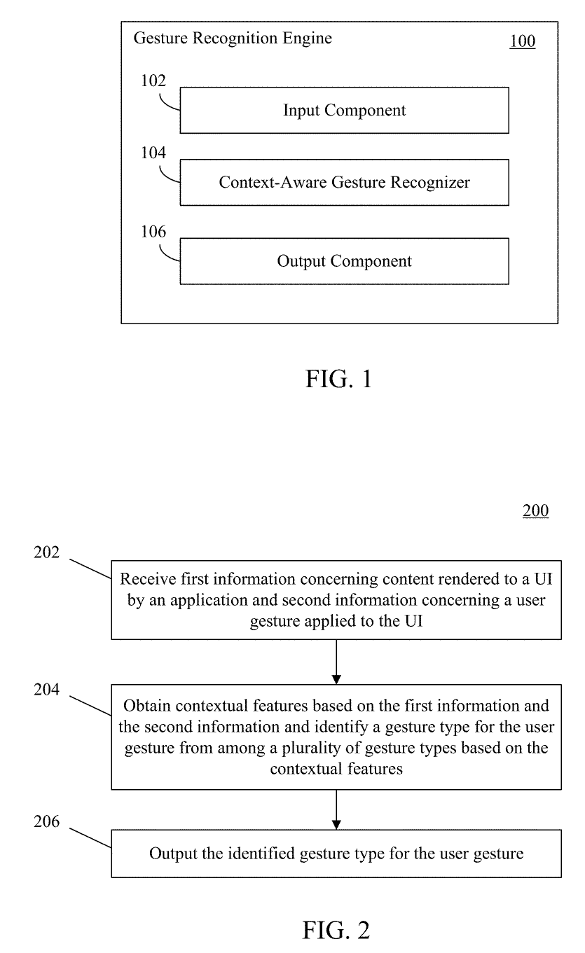

FIG. 2 shows a flowchart 200 of method of generating a gesture type decision in accordance with an embodiment. As an example, the method of flowchart 200 could be performed by gesture recognition engine 100 of FIG. 1.

Flowchart 200 of FIG. 2 begins at step 202 with the receiving of first information concerning content rendered to a UI (e.g., non-gesture content rendered by an application) and second information concerning a user gesture applied to the UI. The first information and/or the second information may be received from an application. The first information may comprise an abstracted view of the content rendered to the UI. For example, the first information may comprise a bounding box and a textual baseline for any textual content in the bounding box. As discussed in more detail herein, the use of a textual baseline is beneficial in that it allows a number of different gestures and annotations to be detected that would otherwise be difficult to detect without knowledge of the textual baseline. However, the first information may include a variety of other types of information about the content rendered to the UI as will be discussed in more detail herein. As an example, step 202 of flowchart 200 may be performed by input component 102 of FIG. 1.

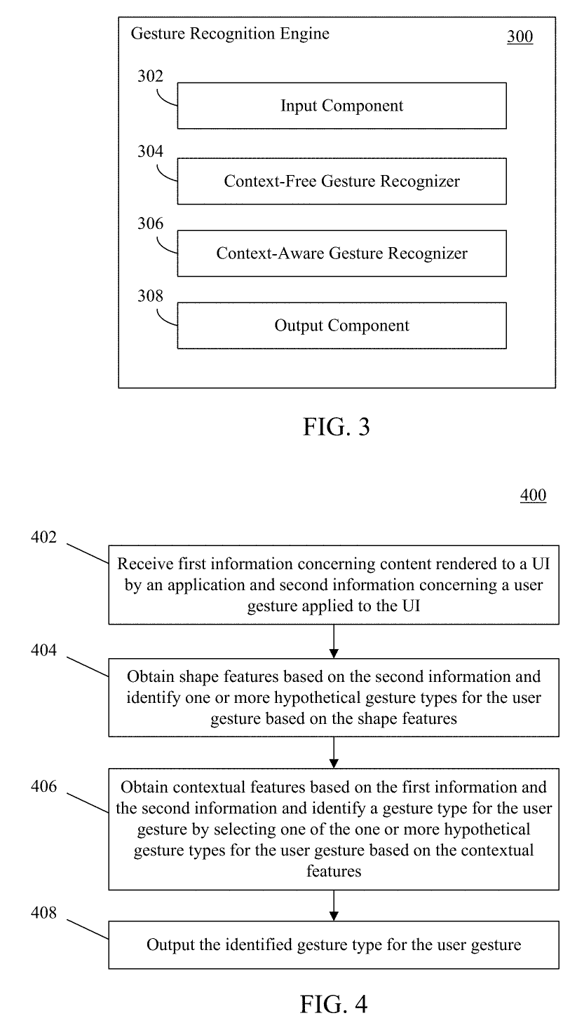

In step 204, contextual features are obtained based on the first information and the second information and a gesture type is identified for the user gesture from among a plurality of gesture types based on the contextual features. The contextual features represent interrelationships between the content rendered to the UI and the user gesture applied to the UI. A variety of example contextual features will be described below in reference to FIG. 3. The gesture type is identified by taking the contextual features into account. This results in improved functionality for a gesture recognition system when attempting to detect gestures that have been entered in a free form by a user on other previously rendered content, including previously-rendered non-gesture content such as text. For example, recognizing a strike-through gesture often requires recognizing the presence and position of the non-gesture text that is being annotated as well as the position of the strike-through gesture itself with respect to the non-gesture text. As an example, step 204 of flowchart 200 may be performed by context-aware gesture recognizer 104 of FIG. 1.

In step 206, the identified gesture type for the user gesture is output. For example, the identified gesture type may be output to an application via an API, and the application may then take some action based on the identified gesture type. In further accordance with this example, the application can then use the output gesture type to modify (e.g., edit or annotate) the content displayed on the user interface of the application. Step 206 of flowchart 200 may, for example, be performed by output component 106 shown in FIG. 1.

FIG. 3 is a block diagram of a gesture recognizer engine 300 in accordance with another embodiment. Gesture recognizer 300 may represent a particular implementation of gesture recognizer 100 as previously described in reference to FIG. 1.

As shown in FIG. 3, gesture recognition engine 300 includes an input component 302, a context-free gesture recognizer 304, a context-aware gesture recognizer 306, and an output component 308. Each of these components may be implemented in software (e.g., as program logic executed by one or more processors), in hardware (as one or more digital and/or analog circuits), or as a combination of software and hardware.

Input component 302 is configured to receive first information concerning content rendered to a UI and second information concerning a user gesture applied to the UI. The first information and/or the second information may be provided to input component 302 by an application that invokes gesture recognition engine 300. The first information and the second information may be substantially the same as the first information and the second information described above in reference to FIGS. 1 and 2, and thus will not be described again herein for the sake of brevity.

Context-free gesture recognizer 304 is configured to obtain shape features based on the second information and identify one or more hypothetical gesture types for the user gesture based on the shape features. For example, context-free gesture recognizer 304 may obtain shape features based on the second information, wherein such shape features may include a curvature of a stroke associated with the user gesture, a degree of horizontal and/or vertical variation in a stroke associated with the user gesture, and/or a relative amount of horizontal to vertical variation in a stroke associated with the user gesture, although these are examples only and are not intended to be limiting. It is also noted that a user gesture may comprise more than one stroke and thus the shape features may relate to multiple strokes.

Based on these shape features, context-free gesture recognizer 304 identifies one or more hypothetical gesture types for the user gesture wherein the hypothetical gesture types are selected from a plurality of gesture types. As will be discussed in more detail herein, the plurality of gesture types may include a strike-through, a scratch-out, a split, a join, an insertion, a commit, an overwrite, or an addition of new content (e.g., in the middle or at the end of previously-rendered content), although these examples are not intended to be limiting. To recognize the addition of new content, context-free gesture recognizer 304 may be configured to disambiguate between various gesture types and the addition of new content. For example, context-free gesture recognizer 304 may be configured to disambiguate between an instance in which a user has drawn a commit gesture at the end of a line and one in which the user has drawn the letter “J” at the end of a line. Depending upon the implementation, context-free gesture recognizer 304 may be implemented using a decision tree recognizer, a heuristic recognizer, or a neural network recognizer, although these are examples only and are not intended to be limiting.

Context-aware gesture recognizer 306 is configured to obtain contextual features based on the first information and the second information and identify a gesture type for the user gesture by selecting one of the one or more hypothetical gesture types for the user gesture based on the contextual features. In this manner, context-aware gesture recognizer 306 may confirm or validate a hypothesis presented by context-free gesture recognizer 304.

The contextual features utilized by context-aware gesture recognizer 306 may include, for example and without limitation: (A) a ratio of (1) an area of intersection of a node associated with the content rendered to the UI and (2) an area of a stroke associated with the user gesture; (B) a ratio of (1) an area of intersection of a node associated with the content rendered to the UI and (2) the node area; (C) a ratio of (1) a projected distance of a stroke associated with the user gesture along a major axis and (2) a projected distance of a node associated with the content rendered to the UI along the major axis; (D) a ratio of (1) a projected distance of a stroke associated with the user gesture along a minor axis and (2) a projected distance of a node associated with the content rendered to the UI along the minor axis; (E) a ratio of (1) a distance between a first point of a stroke associated with the user gesture and a closest point on a node associated with the content rendered to the UI and (2) a projected distance of the node on a minor axis; and (F) a ratio of (1) a distance between a last point of a stroke associated with the user gesture and a closest point on a node associated with the content rendered to the UI and (2) a projected distance of the node on a minor axis. Still other contextual features may be utilized as will be appreciated by persons skilled in the art based on the teachings provided herein. Such contextual features may take into account both the first information and the second information to determine interrelationships between the content rendered to the UI and the user gesture applied to the UI.

For example, a gesture type hypothesis may be received from context-free gesture recognizer 304 that indicates that the gesture type is a strike-out gesture. Context-aware gesture recognizer may test this hypothesis by examining contextual feature (C) noted above (a ratio of (1) a projected distance of a stroke associated with the user gesture along a major axis and (2) a projected distance of a node associated with the content rendered to the UI along the major axis). If the ratio is much less than one (e.g., less than 0.8), the gesture may be determined not to be a strike-out. However, if the ratio is close to one (e.g., greater than or equal to 0.8), the gesture type hypothesis remains valid. This is merely one example of how a contextual feature may be used to validate or invalidate a gesture type hypothesis.

Depending upon the implementation, context-aware gesture recognizer 306 may be implemented using a decision tree recognizer, a heuristic recognizer, or a neural network recognizer, although these are examples only and are not intended to be limiting.

Output component 308 outputs the identified gesture type for the user gesture. For example, output component 308 may output the identified gesture type to an application that invoked gesture recognition engine 300. The gesture type may represent a type of annotation or gesture that gesture recognition engine 300 determines has been applied by a user to the UI. In an embodiment, input component 302 and output component 308 comprise part of an API that can be used by an application to invoke gesture recognition engine 300.

FIG. 4 shows a flowchart 400 of method of generating a gesture type decision in accordance with another embodiment. As an example, the method of flowchart 400 could be performed by gesture recognition engine 300 of FIG. 3.

Flowchart 400 of FIG. 4 begins at step 402 with the receiving of first information concerning content rendered to a UI (e.g., non-gesture content rendered by an application) and second information concerning a user gesture applied to the UI. The first information and second information may be substantially the same as that described above in reference to flowchart 200, and thus will not be described here for the sake of brevity. As an example, step 402 of flowchart 400 may be performed by input component 302 of FIG. 3.

In step 404, shape features are obtained based on the second information and one or more hypothetical gesture types are identified for the user gesture based on the shape features. As noted above, such shape features may include but are by no means limited to a curvature of a stroke associated with the user gesture, a degree of horizontal and/or vertical variation in a stroke associated with the user gesture, and/or a relative amount of horizontal to vertical variation in a stroke associated with the user gesture. As was also noted above, a user gesture may comprise more than one stroke and thus the shape features may relate to multiple strokes. The one or more hypothetical gesture types may be selected from a plurality of gesture types that include a strike-through, a scratch-out, a split, a join, an insertion, a commit, an overwrite, or an addition of new content (e.g., in the middle or at the end of previously-rendered content), although these examples are not intended to be limiting. As an example, step 404 of flowchart 400 may be performed by context-free gesture recognizer 304 of FIG. 3.

In step 406, contextual features are obtained based on the first information and the second information and a gesture type is identified for the user gesture by selecting one of the one or more hypothetical gesture types for the user gesture based on the contextual features. In this manner, context-aware gesture recognizer 306 may confirm a hypothesis presented by context-free gesture recognizer 304. A variety of example contextual features were described above as part of the description context-aware gesture recognizer 306 and thus will not be described here for the sake of brevity. As an example, step 406 of flowchart 400 may be performed by context-aware gesture recognizer 306 of FIG. 3.

In step 408, the identified gesture type for the user gesture is output. For example, the identified gesture type may be output to an application via an API, and the application may then take some action based on the identified gesture type. In further accordance with this example, the application can then use the output gesture type to modify (e.g., edit or annotate) the content displayed on the user interface of the application. Step 408 of flowchart 400 may, for example, be performed by output component 106 shown in FIG. 1.

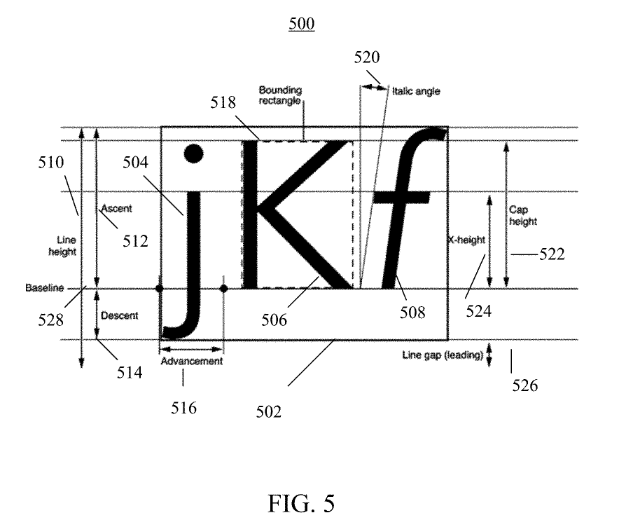

FIG. 5 is an example of an abstracted view 500 of non-gesture content (e.g., text) that may be rendered to a UI in accordance with an embodiment. When a context-aware gesture recognizer (such as context-aware gesture recognizer 104 of FIG. 1 or context-aware gesture recognizer 306 of FIG. 3) receives first information concerning non-gesture (e.g., text) content rendered to a UI, such first information may comprise various items of information illustrated in FIG. 5. This information may include a word bounding rectangle 502 that encompasses one or more text character 604, 606 and 608 as well as other information about such text characters. This other information may include for example a line height 510, an ascent of the text 512, a descent of the text 514, an advancement of the text 516, a cap height (or cap-line) 522, an x-height (or mean-line) 524, and a line gap 526 for any text present in word bounding rectangle 502. The abstracted view also may include a text bounding rectangle 518 around a text character that identifies the outer boundaries of the character. The slope of a character 508 may be used to determine an italic angle 520 of the character that can be examined to determine if the text is in italics. The abstracted view may also include information such as a textual baseline 528 based upon the detected position of characters 504, 506 and 508. As discussed herein, textual baseline 528, as well as the other items of information shown in FIG. 5, constitute information that can be helpful or essential to recognizing particular user gestures. This is because such information can be used to derive contextual features that can help in determining which user gesture the user is applying to the UI. Although not shown in FIG. 5, other types of information that may be useful in this regard may include a font type and a font-specific characteristic.

FIG. 6 is a block diagram of a gesture recognition engine 600 in accordance with a further embodiment. Gesture recognition engine 600 may comprise an example implementation of gesture recognition engine 100 of FIG. 1 or gesture recognition engine 300 of FIG. 3. As shown in FIG. 6, gesture recognition engine 600 includes various logic blocks or components that are used to recognize specific gestures or annotations. Each of these logic blocks or components may be implemented in software (e.g., as program logic executed by one or more processors), in hardware (as one or more digital and/or analog circuits), or as a combination of software and hardware. Each of these logic blocks may be implemented as part of a context-aware gesture recognizer, as part of a context-free gesture recognizer, or may be implemented through the combination of a context-aware gesture recognizer and a context-free gesture recognizer.

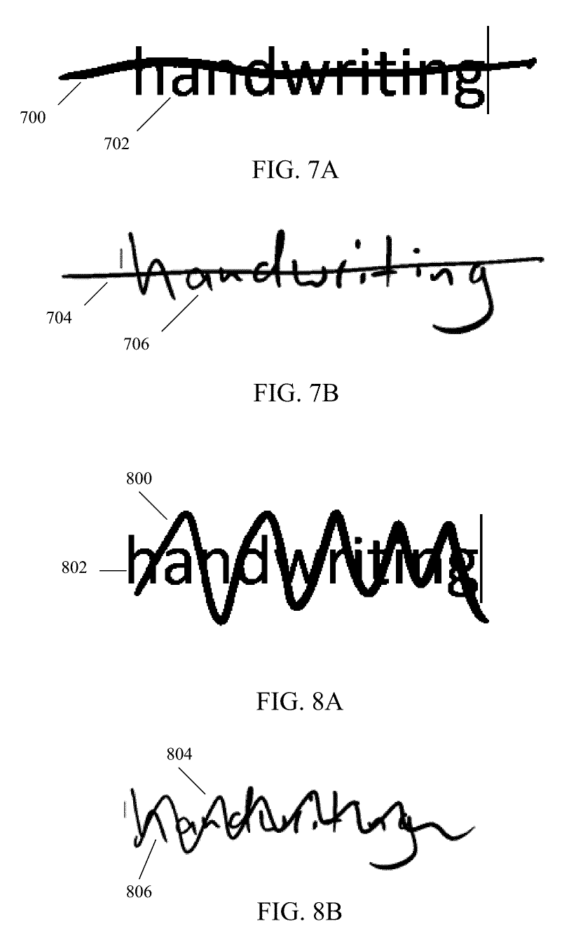

The exemplary gesture recognition logic for detecting gestures includes strike-through gesture recognition logic 602, scratch-out gesture recognition logic 604, split gesture recognition logic 606, join gesture recognition logic 608, commit/new line gesture recognition logic 610, overwrite gesture recognition logic 612, insertion between words gesture recognition logic 614 and insertion between words gesture recognition logic 616. Each gesture recognition component includes the logic and parameters necessary to recognize the particular gesture for which the component is configured. These gestures are discussed in more detail with respect to FIGS. 7-15. In addition, annotated node identifier logic 618 and annotating node identifier logic 620 are provided to assist in the identification of certain gestures, such as a connect or directional connect gesture, that depend upon a relationship between objects.

FIGS. 7A and 7B are illustrations of a strike-through gesture on non-gesture writing and a strike-through gesture on gesture writing, respectively, that may be recognized by a gesture recognition engine in accordance with an embodiment.

The strike-through gesture of FIG. 7A consists of a strike-through gesture 700 over non-gesture text 702. For the gesture recognition engine to recognize strike-through gesture 700 as a strike-through gesture, it may recognize non-gesture text 702 as text and the position of strike-through gesture 700 with respect to non-gesture text 702, and/or other interrelationships between strike-through gesture 700 and non-gesture text 702 as represented by contextual features. For example, first information about non-gesture text 702 and second information about strike-through gesture 700 may be combined to determine various contextual features. These contextual features may be used to determine that strike-through gesture 700 applies to non-gesture text 702.

The strike-through gesture of FIG. 7B consists of a strike-through gesture 704 over gesture text 706. For the gesture recognition engine to recognize strike-through gesture 704 as a strike-through gesture, it may recognize gesture text 706 as text and the position of strike-through gesture 704 with respect to gesture text 706, and/or other interrelationships between strike-through gesture 704 and gesture text 706 as represented by contextual features. For example, first information about gesture text 706 and second information about strike-through gesture 704 may be combined to determine various contextual features. These contextual features may be used to determine that strike-through gesture 704 applies to gesture text 706.

FIGS. 8A and 8B are illustrations of a scratch-out gesture on non-gesture writing and a scratch-out gesture on gesture writing, respectively, that may be recognized by a gesture recognition engine in accordance with an embodiment.

The scratch-out gesture of FIG. 8A consists of a scratch-out gesture 800 over non-gesture text 802. For the gesture recognition engine to recognize scratch-out gesture 800 as a scratch-out gesture, it may recognize non-gesture text 802 as text and the position of scratch-out gesture 800 with respect to non-gesture text 802, and/or other interrelationships between scratch-out gesture 800 and non-gesture text 802 as represented by contextual features. For example, first information about non-gesture text 802 and second information about scratch-out gesture 800 may be combined to determine various contextual features. These contextual features may be used to determine that scratch-out gesture 800 applies to non-gesture text 802.

The scratch-out gesture of FIG. 8B consists of a scratch-out gesture 804 over gesture text 806. For the gesture recognition engine to recognize scratch-out gesture 804 as a scratch-out gesture, it may recognize gesture text 806 as text and the position of scratch-out gesture 804 with respect to gesture text 806, and/or other interrelationships between scratch-out gesture 804 and gesture text 806 as represented by contextual features. For example, first information about gesture text 806 and second information about scratch-out gesture 704 may be combined to determine various contextual features. These contextual features may be used to determine that scratch-out gesture 804 applies to gesture text 806.

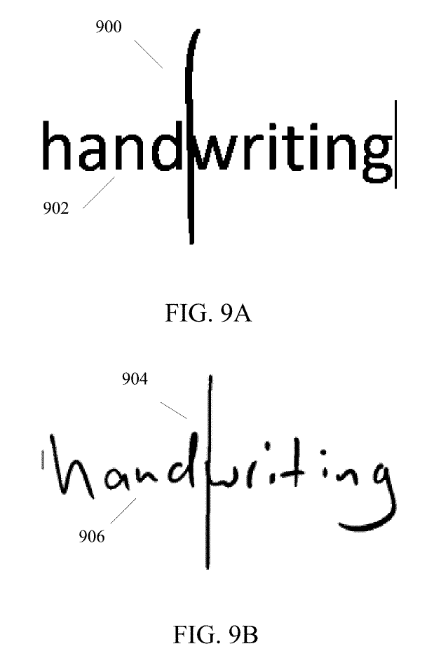

FIGS. 9A and 9B are illustrations of a split within a word gesture on non-gesture writing and a split within a word gesture on gesture writing, respectively, that may be recognized by a gesture recognition engine in accordance with an embodiment.

The split within a word gesture of FIG. 9A consists of a gesture 900 that extends vertically through non-gesture text 902. For the gesture recognition engine to recognize gesture 900 as a split within a word gesture, it may recognize non-gesture text 902 as text and the position of gesture 900 with respect to non-gesture text 902, and/or other interrelationships between gesture 900 and non-gesture text 902 as represented by contextual features. For example, first information about non-gesture text 902 and second information about gesture 900 may be combined to determine various contextual features. These contextual features may be used to determine that gesture 900 applies to non-gesture text 902 and where it applies.

The split within a word gesture of FIG. 9B consists of a vertical gesture 904 over gesture text 906. For the gesture recognition engine to recognize gesture 904 as a split within a word gesture, it may recognize gesture text 906 as text and the position of gesture 904 with respect to gesture text 906, and/or other interrelationships between gesture 904 and gesture text 906 as represented by contextual features. For example, first information about gesture text 906 and second information about gesture 904 may be combined to determine various contextual features. These contextual features may be used to determine that gesture 904 applies to gesture text 906 and where it applies.

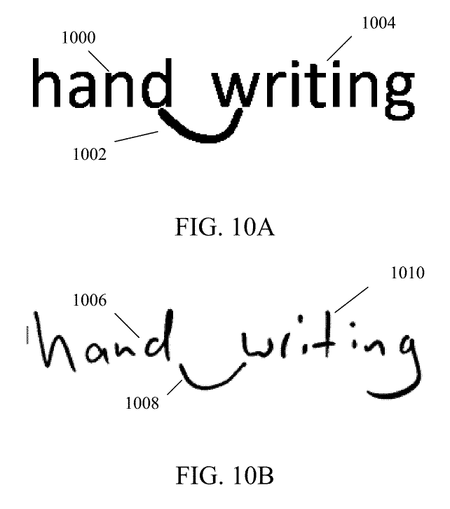

FIGS. 10A and 10B are illustrations of a join gesture on non-gesture writing and a join gesture on gesture writing, respectively, that may be recognized by a gesture recognition engine in accordance with an embodiment.

The join gesture of FIG. 10 consists of a curved line gesture 1002 that connects non-gesture text words 1000 and 1004. For the gesture recognition engine to recognize curved line gesture 1002 as a join gesture, it may recognize non-gesture text words 1000 and 1004 as text, the position of curved line gesture 1002 with respect to each of non-gesture text words 1000 and 1004, and/or other interrelationships between curved line gesture 1002 and non-gesture text words 1000 and 1004 as represented by contextual features. For example, first information about non-gesture text word 1000 and/or non-gesture text word 1004 and second information about curved line gesture 1002 may be combined to determine various contextual features. These contextual features may be used to determine that curved line gesture 1002 is intended to modify the spacing between non-gesture text words 1000 and 1004.

The join gesture of FIG. 10B consists of a curved line gesture 1008 that connects gesture text words 1006 and 1010. For the gesture recognition engine to recognize curved line gesture 1008 as a join gesture, it may recognize gesture text words 1006 and 1010 as words, the position of curved line gesture 1008 with respect to gesture text words 1006 and 1010, and/or other interrelationships between curved line gesture 1008 and gesture text words 1006 and 1010 as represented by contextual features. For example, first information about gesture text word 1006 and/or gesture text word 1010 and second information about curved line gesture 1008 may be combined to determine various contextual features. These contextual features may be used to determine that curved line gesture 1008 is intended to modify the spacing between gesture text words 1006 and 1010.

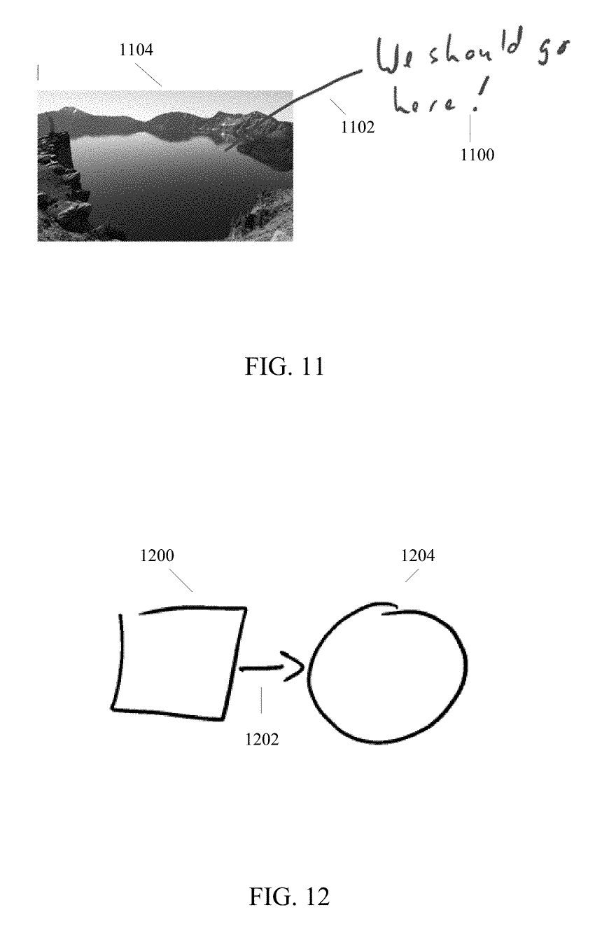

FIG. 11 is an illustration of a connect gesture 1102 that may be recognized by a gesture recognition engine in accordance with an embodiment. The connect gesture consists of a line gesture 1102 that connects gesture content such as text 1100 to non-gesture content such as an image 1104. To recognize the connect gesture, the gesture recognition engine may recognize interrelationships between line gesture 1102, text 1100 and image 1104 as represented by contextual features. For example, first information about text 1100 and/or image 1104 and second information about line gesture 1102 may be combined to determine various contextual features. These contextual features may be used to determine that line gesture 1102 is a connect gesture.

FIG. 12 is an illustration of a directional connect gesture that may be recognized by a gesture recognition engine in accordance with an embodiment. Directional connect gesture 1202 consists of an arrow that connects gesture content such as square 1200 to other gesture content such as a circle 1204 in a directional manner, i.e. square 1200 to circle 1204. To recognize the directional connect gesture, the gesture recognition engine may recognize interrelationships between directional connect gesture 1202, square 1200 and circle 1204 as represented by contextual features. For example, first information about square 1200 and/or circle 1204 and second information about directional connect gesture 1202 may be combined to determine various contextual features. These contextual features may be used to determine that directional connect gesture 1202 directionally connects square 1200 and circle 1204.

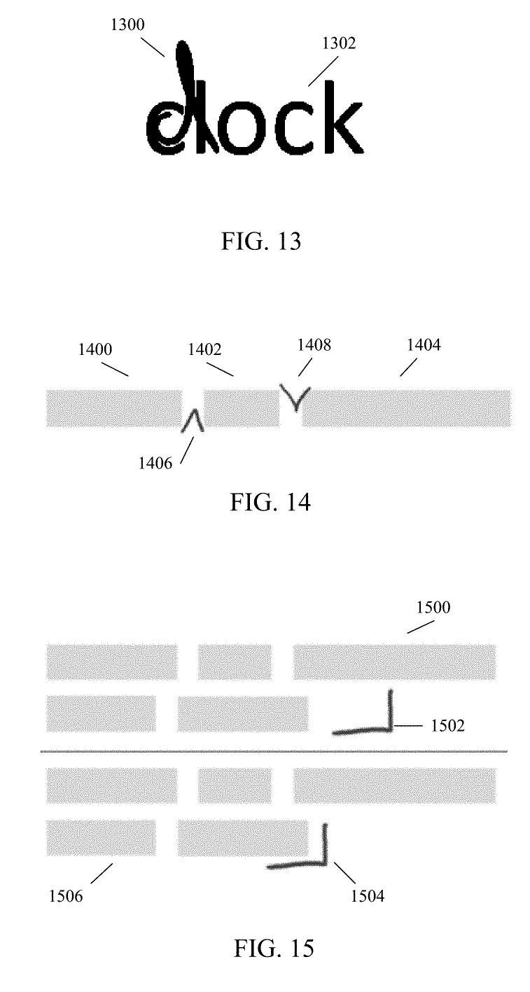

FIG. 13 is an illustration of an overwrite gesture on non-gesture content that may be recognized by a gesture recognition engine in accordance with an embodiment. The overwrite gesture consists of gesture text 1300 drawn over non-gesture text 1302. To recognize the overwrite gesture, the gesture recognition engine may recognize that non-gesture text 1302 is text and that gesture text 1300 is text that is to some degree aligned with a portion of non-gesture text 1302, and/or other interrelationships between gesture text 1300 and non-gesture text 1302 as represented by contextual features. For example, first information about non-gesture text 1302 and second information about gesture text 1300 may be combined to determine various contextual features. These contextual features may be used to determine that gesture text 1300 is intended to overwrite a portion of non-gesture text 1302.

FIG. 14 is an illustration of an insertion between words gesture on non-gesture content that may be recognized by a gesture recognition engine in accordance with an embodiment. A first insertion between words gesture consists of a chevron gesture 1406 that is used to indicate that content should be inserted between a word 1400 and a word 1402. To recognize the first insertion between words gesture, the gesture recognition engine may recognize that chevron gesture 1406 is located in between word 1400 and word 1402, and/or other interrelationships between chevron gesture 1406 and words 1400 and 1402 as represented by contextual features. For example, first information about words 1400 and 1402 and second information about chevron gesture 1406 may be combined to determine various contextual features. These contextual features may be used to determine that chevron gesture 1406 is intended to cause an insertion between words 1400 and 1402.

As further shown in FIG. 14, a second insertion between words gesture consists of a chevron gesture 1408 that is used to indicate that content should be inserted between word 1402 and a word 1404. To recognize the second insertion between words gesture, the gesture recognition engine may recognize that chevron gesture 1408 is located in between word 1402 and word 1404, and/or other interrelationships between chevron gesture 1408 and words 1402 and 1404 as represented by contextual features. For example, first information about words 1402 and 1404 and second information about chevron gesture 1408 may be combined to determine various contextual features. These contextual features may be used to determine that chevron gesture 1408 is intended to cause an insertion between words 1402 and 1404.

FIG. 15 is an illustration of a commit or new line gesture on non-gesture content that may be recognized by a gesture recognition engine in accordance with an embodiment. A first commit or new line gesture consists of two approximately perpendicular lines 1502 positioned at or near the end of text 1500 that is used to indicate a new line or a commitment to a particular entry. To recognize and implement the new line or commit gesture, the gesture recognition engine may recognize that lines 1502 are positioned proximate to the end of text 1500, and/or other interrelationships between lines 1502 and text 1500 as represented by contextual features. For example, first information about text 1500 and second information about lines 1502 may be combined to determine various contextual features. These contextual features may be used to determine that the first commit or new line gesture applies to text 1500.

As further shown in FIG. 15, a second commit or new line gesture consists of two approximately perpendicular lines 1504 positioned at or near the end of text 1506 that is used to indicate a new line or a commitment to a particular entry. To recognize and implement the second new line or commit gesture, the gesture recognition engine may recognize that lines 1504 are positioned proximate to the end of text 1506, and/or other interrelationships between lines 1504 and text 1506 as represented by contextual features. For example, first information about text 1506 and second information about lines 1504 may be combined to determine various contextual features. These contextual features may be used to determine that the second commit or new line gesture applies to text 1506.

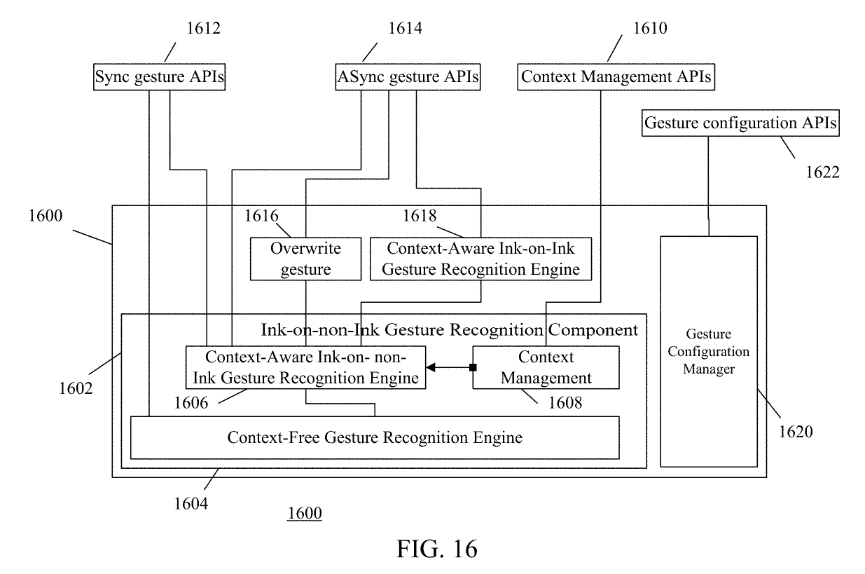

FIG. 16 is a block diagram of a system 1600 for gesture recognition in accordance with an embodiment. System 1600 includes a gesture recognition engine 1600 with an ink-on-non-ink (or gesture on non-gesture) gesture recognition component 1602. Ink-on-non-ink gesture recognition component 1602 includes a context-free gesture recognition engine 1604 that attempts to recognize a user gesture based on information about one or more strokes associated with the user gesture only and generate a gesture type hypothesis. The gesture type hypothesis generated by context-free gesture recognition engine 1604 is passed to a context-aware ink-on-non-ink gesture recognition engine 1606 that uses contextual features that express interrelationships between the ink and non-ink content to test the gesture hypothesis received from context-free gesture recognition engine 1604 based upon the contextual features and generate a context-aware hypothesis.

With continued reference to system 1600 of FIG. 16, a context management engine 1608 receives context management instructions from context management application programming interfaces 1610 that allow developers to customize various aspects of the gesture recognition process. The output of context-aware ink-on-non-ink gesture recognition engine 1606 may be provided directly to synchronous gesture APIs 1612 and asynchronous gesture APIs 1614. The output of context-aware ink-on-non-ink gesture recognition engine 1606 may also be provided to a context-aware ink-on-ink gesture recognition engine 1618 that further tests the gesture type hypothesis based on the context provided by the ink-on-ink content. An overwrite gesture recognition engine 1616 also receives the gesture type hypothesis from context-aware ink-on-non-ink gesture recognition engine 1606 and checks the gesture hypothesis to see if the gesture is an overwrite gesture. The output of overwrite gesture recognition engine 1616 and context-aware ink-on-ink gesture recognition engine 1618 may be provided to synchronous gesture APIs 1612 and asynchronous gesture APIs 1614.

A gesture configuration manager 1620 allows developers and advanced users to customize the gesture configurations using a gesture configuration application programming interface 1622. For example, gesture configuration manager 1620 can be used to alter the gesture recognition for different languages where some types of gestures may conflict with characters or symbols of one or more different languages. By providing configuration information from an application, gesture recognition can be “turned off” for selected gestures that are deemed to be problematic within the context of that application.

By way of example, gesture configuration manager 1620 may receive configuration information from an application, and based on the configuration information, identify a plurality of eligible gesture types and at least one non-eligible gesture type from among a plurality of gesture types. When other components of gesture recognition engine 1600 operate to recognize a given user gesture, such components will not consider any non-eligible gesture types for recognition purposes. Such components will only consider eligible gesture types for recognition purposes. In this manner, an application can determine which gestures should and shouldn't be recognized by gesture recognition engine 1600.

In an embodiment, the configuration information that is provided to gesture configuration manager 1620 may comprise a language or an identifier thereof, and based on the language or identifier thereof, gesture configuration manager 1620 may itself determine which gesture types to deem eligible for recognition and which gestures types to deem ineligible. However, this is only an example, and various other techniques may be used to inform gesture configuration manager 1620 to turn off recognition for certain gesture types.

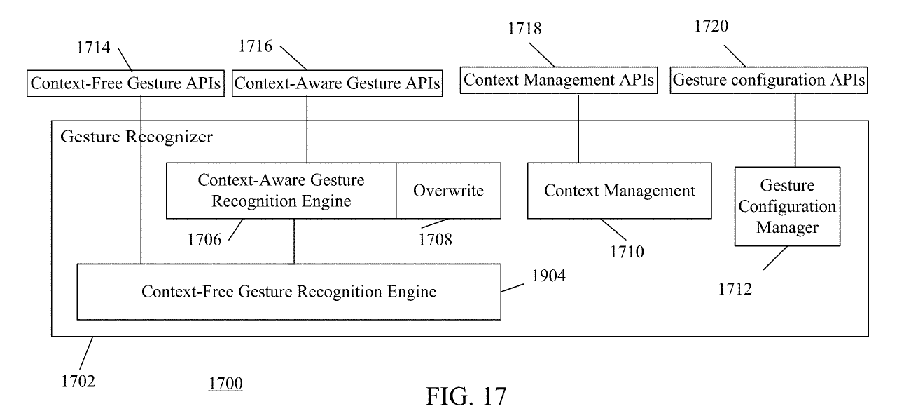

FIG. 17 is a block diagram of a system 1700 for gesture recognition in accordance with another embodiment. System 1700 includes a gesture recognizer 1702. Gesture recognizer 1702 includes a context-free gesture recognition engine 1704 that attempts to detect a user gesture based only on stroke information associated with the user gesture and generate a gesture type hypothesis. The output of context-free gesture recognition engine 1704 is provided directly to a context-free gesture API 1714 for remote access. The output of context-free gesture recognition engine 1704 is also passed to a context-aware gesture recognition engine 1706 that examines contextual features that express interrelationships between the user gesture and previously rendered content to test the gesture type hypothesis received from context-free gesture recognition engine 1704 and generate a context-aware gesture type hypothesis. Context-aware gesture recognition engine 1706 includes an overwrite gesture recognition engine 1708 that further tests the gesture type hypothesis to determine if user gesture comprises an overwrite gesture. The output of context-aware gesture recognition engine 1706 is provided to a context-aware gesture API 1716. A context management engine 1710 receives context management instructions from a context management API 1718 that allows developers to customize their gesture recognition and the contextual features extracted and considered. A gesture configuration manager 1712 allows users and developers to customize the gesture configurations using a gesture configuration API 1720 to take into account any individual requirements and/or to accommodate foreign languages requirements (e.g., by turning on and off gesture recognition for certain gesture types as discussed above in reference to FIG. 16).

### Example Computer System Implementation

Any of the components of gesture recognition engine 100, gesture recognition engine 300, gesture recognition engine 600, system 1600, and system 1700 and any of the steps of the flowcharts of FIGS. 2 and 4 may be implemented in hardware, or hardware with any combination of software and/or firmware, including being implemented as computer program code configured to be executed in one or more processors and stored in a computer readable storage medium, or being implemented as hardware logic/electrical circuitry, such as being implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

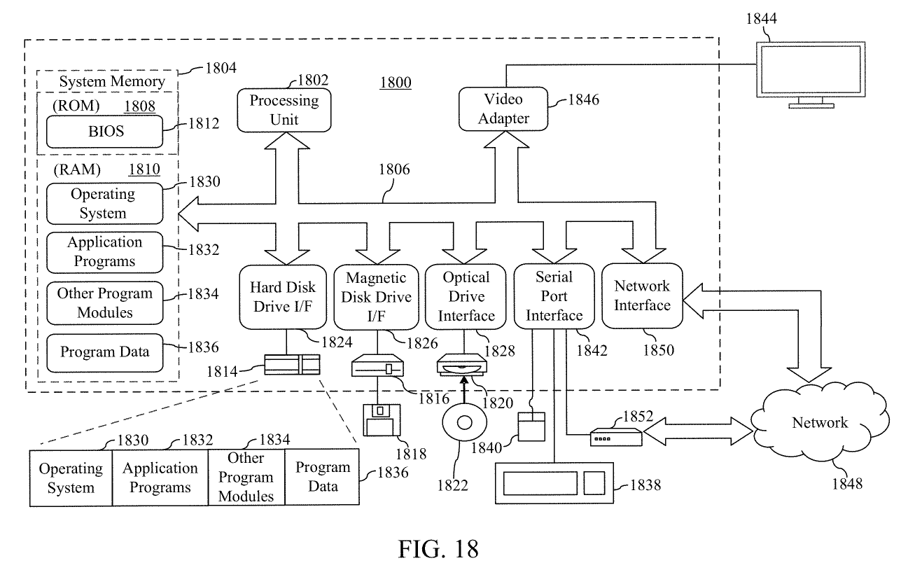

FIG. 18 depicts an example processor-based computer system 1800 that may be used to implement various embodiments described herein. For example, system 1800 may be used to implement any of the components of gesture recognition engine 100, gesture recognition engine 300, gesture recognition engine 600, system 1600, and system 1700 as described above. System 1800 may also be used to implement any or all the steps of the flowcharts depicted in FIGS. 2 and 4. The description of system 1800 provided herein is provided for purposes of illustration, and is not intended to be limiting. Embodiments may be implemented in further types of computer systems, as would be known to persons skilled in the relevant art(s).

As shown in FIG. 18, system 1800 includes a processing unit 1802, a system memory 1804, and a bus 1806 that couples various system components including system memory 1804 to processing unit 1802. Processing unit 1802 may comprise one or more microprocessors or microprocessor cores. Bus 1806 represents one or more of any of several types of bus structures, including a memory bus or memory controller, a peripheral bus, an accelerated graphics port, and a processor or local bus using any of a variety of bus architectures. System memory 1804 includes read only memory (ROM) 1808 and random access memory (RAM) 1810. A basic input/output system 1812 (BIOS) is stored in ROM 1808.

System 1800 also has one or more of the following drives: a hard disk drive 1814 for reading from and writing to a hard disk, a magnetic disk drive 1816 for reading from or writing to a removable magnetic disk 1818, and an optical disk drive 1820 for reading from or writing to a removable optical disk 1822 such as a CD ROM, DVD ROM, BLU-RAY™ disk or other optical media. Hard disk drive 1814, magnetic disk drive 1816, and optical disk drive 1820 are connected to bus 1806 by a hard disk drive interface 1824, a magnetic disk drive interface 1826, and an optical drive interface 1828, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules or components may be stored on the hard disk, magnetic disk, optical disk, ROM, or RAM. These program modules include an operating system 1830, one or more application programs 1832, other program modules 1834, and program data 1836. In accordance with various embodiments, the program modules may include computer program logic that is executable by processing unit 1802 to perform any or all the functions and features of gesture recognition engine 100, gesture recognition engine 300, gesture recognition engine 600, system 1600, and system 1700 as described above. The program modules may also include computer program logic that, when executed by processing unit 1802, performs any of the steps or operations shown or described in reference to the flowcharts of FIGS. 2 and 4.

A user may enter commands and information into system 1800 through input devices such as a keyboard 1838 and a pointing device 1840. Other input devices (not shown) may include a microphone, joystick, game controller, scanner, or the like. In one embodiment, a touch screen is provided in conjunction with a display 1844 to allow a user to provide user input via the application of a touch (as by a finger or stylus for example) to one or more points on the touch screen. These and other input devices are often connected to processing unit 1802 through a serial port interface 1842 that is coupled to bus 1806, but may be connected by other interfaces, such as a parallel port, game port, or a universal serial bus (USB). Such interfaces may be wired or wireless interfaces.

A display 1844 is also connected to bus 1806 via an interface, such as a video adapter 1846. In addition to display 1844, system 1800 may include other peripheral output devices (not shown) such as speakers and printers.

System 1800 is connected to a network 1848 (e.g., a local area network or wide area network such as the Internet) through a network interface or adapter 1850, a modem 1852, or other suitable means for establishing communications over the network. Modem 1852, which may be internal or external, is connected to bus 1806 via serial port interface 1842. As used herein, the terms “computer program medium,” “computer-readable medium,” and “computer-readable storage medium” are used to generally refer to memory devices or storage structures such as the hard disk associated with hard disk drive 1814, removable magnetic disk 1818, removable optical disk 1822, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1832 and other program modules 1834) may be stored on the hard disk, magnetic disk, optical disk, ROM, or RAM. Such computer programs may also be received via network interface 1850, serial port interface 1842, or any other interface type. Such computer programs, when executed or loaded by an application, enable system 1800 to implement features of embodiments of the present methods and systems discussed herein. Accordingly, such computer programs represent controllers of the system 1800.

Embodiments are also directed to computer program products comprising software stored on any computer useable medium. Such software, when executed in one or more data processing devices, causes a data processing device(s) to operate as described herein. Embodiments of the present methods and systems employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

### Additional Exemplary Embodiments

In an embodiment, a user gesture recognition system comprises a memory that stores program logic and a processor operable to access the memory and to execute the program logic. The program logic includes an input component, a context-aware gesture recognizer and an output component. The input component receives first information concerning content rendered to a user interface (UI) and second information concerning a user gesture applied to the UI. The context-aware gesture recognizer obtains contextual features based on the first information and the second information and identifies a gesture type for the user gesture from among a plurality of gesture types based on the contextual features. The output component outputs the identified gesture type for the user gesture.

In an embodiment, the program logic further comprises a context-free gesture recognizer that obtains shape features based on the second information and identifies one or more hypothetical gesture types for the user gesture based on the shape features. The context-aware gesture recognizer is configured to identify the gesture type for the user gesture from among the plurality of gesture types by selecting one of the one or more hypothetical gestures types for the user gesture based on the contextual features.

In an embodiment, the context-aware gesture recognizer is implemented as one of a decision tree recognizer, a heuristic recognizer or a neural network recognizer.

In an embodiment, the context-free gesture recognizer is implemented as one of a decision tree recognizer, heuristic recognizer or a neural network recognizer.

In an embodiment, the content comprises at least one of gesture content, text content, shape content, picture content, mathematical symbol content or musical symbol content.

In an embodiment, the plurality of gesture types includes one or more of a strike-through, a scratch-out, a split, a join, an insertion, a commit, an overwrite, and an addition of new content.

In an embodiment, the second information comprises information about one or more strokes made by the user.

In an embodiment, the first information includes one or more of an image that includes the content rendered to the UI, a textual baseline, a bounding box, a word bounding rectangle, a character bounding rectangle, a spacing between characters, a line height, an ascent, a descent, a line gap, an advancement, an x-height, a cap height, an italic angle, a font type, and a font-specific characteristic.

In an embodiment, the input component and the output component comprise part of an application programming interface.

In an embodiment, a computer-implemented method of gesture recognition includes receiving first information concerning content rendered to a UI by an application and second information concerning a user gesture applied to the UI. Contextual features are obtained based on the first information and the second information. A gesture type for the user gesture is identified from among a plurality of gesture types based on the contextual features. The identified gesture type for the user gesture is output to the application.

In an embodiment, shape features are obtained based on the second information and one or more hypothetical gesture types for the user gesture are identified based on the shape features. The gesture type for the user gesture is identified from among the plurality of gesture types by selecting one of the one or more hypothetical gestures types for the user gesture based on the contextual features.

In an embodiment, the content comprises at least one of gesture content, text content, shape content, picture content, mathematical symbol content, or musical symbol content.

In an embodiment, the plurality of gesture types includes one or more of a strike-through, a scratch-out, a split, a join, an insertion, a commit, an overwrite, and an addition of new content.

In an embodiment, the second information comprises information about one or more strokes made by a user.

In an embodiment, the first information includes one or more of: an image that includes the content rendered to the UI, a textual baseline, a bounding box, a word bounding rectangle, a character bounding rectangle, a spacing between characters, a line height, an ascent, a descent, a line gap, an advancement, an x-height, a cap height, an italic angle, a font type, and a font-specific characteristic.

In an embodiment, a user gesture recognition system includes a memory that stores program logic and a processor operable to access the memory and to execute the program logic. The program logic includes an input component, a configuration manager, a context-aware gesture recognizer, and an output component. The input component receives first information concerning content rendered to a UI and second information concerning a user gesture applied to the UI. The configuration manager receives configuration information from the application and, based on the configuration information, identifies a plurality of eligible gesture types and at least one non-eligible gesture type from among a plurality of gesture types. The context-aware gesture recognizer obtains contextual features based on the first information and the second information and identifies a gesture type for the user gesture from among the plurality of eligible gesture types based on the contextual features. The output component outputs the identified gesture type for the user gesture to the application.

In an embodiment, the program logic further includes a context-free gesture recognizer that obtains shape features based on the second information and identifies one or more hypothetical gesture types for the user gesture from among the plurality of eligible gesture types based on the shape features. The context-aware gesture recognizer is configured to identify the gesture type for the user gesture from among the plurality of eligible gesture types by selecting one of the one or more hypothetical gestures types for the user gesture based on the contextual features.

In an embodiment, the configuration information comprises a language.

In an embodiment, the first information includes one or more of an image that includes the content rendered to the UI, a textual baseline, a bounding box, a word bounding rectangle, a character bounding rectangle, spacing between characters, a line height, an ascent, a descent, a line gap, an advancement, an x-height, a cap height, an italic angle, a font type, and a font-specific characteristic.

In an embodiment, the plurality of gesture types includes one or more of a strike-through, a scratch-out, a split, a join, an insertion, a commit, an overwrite, and an addition of new content.

The example embodiments described herein are provided for illustrative purposes, and are not limiting. The examples described herein may be adapted to any type of gesture system or method. Further structural and operational embodiments, including modifications/alterations, will become apparent to persons skilled in the relevant art(s) from the teachings herein.

### CONCLUSION

While various embodiments of the present methods and systems have been described above, it should be understood that they have been presented by way of example only, and not limitation. It will be apparent to persons skilled in the relevant art that various changes in form and detail can be made therein without departing from the spirit and scope of the methods and systems. Thus, the breadth and scope of the present methods and systems should not be limited by any of the above-described exemplary embodiments, but should be defined only in accordance with the following claims and their equivalents.

What is claimed is:

1. A user gesture recognition system, comprising:
a memory that stores program logic; and
a processor operable to access the memory and to execute the program logic, the program logic comprising:
an input component that receives first information concerning content rendered to a user interface (UI) and second information concerning a user gesture applied to the UI;
a context-aware gesture recognizer that obtains contextual features based on the first information and the second information and identifies a gesture type for the user gesture from among a plurality of gesture types based on the contextual features; and
an output component that outputs the identified gesture type for the user gesture.

2. The user gesture recognition system of claim 1, wherein the program logic further comprises:
a context-free gesture recognizer that obtains shape features based on the second information and identifies one or more hypothetical gesture types for the user gesture based on the shape features;
wherein the context-aware gesture recognizer is configured to identify the gesture type for the user gesture from among the plurality of gesture types by selecting one of the one or more hypothetical gestures types for the user gesture based on the contextual features.

3. The user gesture recognition system of claim 1, wherein the context-aware gesture recognizer is implemented as one of a decision tree recognizer, a heuristic recognizer or a neural network recognizer.

4. The user gesture recognition system of claim 2, wherein the context-free gesture recognizer is implemented as one of a decision tree recognizer, a heuristic recognizer or a neural network recognizer.

5. The user gesture recognition system of claim 1, wherein the content comprises at least one of:
gesture content;
text content;
shape content;
picture content;
mathematical symbol content; or
musical symbol content.

6. The user gesture recognition system of claim 1, wherein the plurality of gesture types includes one or more of:
a strike-through;
a scratch-out;
a split;
a join;
an insertion;
a commit;
an overwrite; and
an addition of new content.

7. The user gesture recognition system of claim 1, wherein the second information comprises information about one or more strokes made by the user.

8. The user gesture recognition system of claim 1, wherein the first information includes one or more of:
an image that includes the content rendered to the UI;
a textual baseline;
a bounding box;
a word bounding rectangle;
a character bounding rectangle;
a spacing between characters;
a line height;
an ascent;
a descent;
a line gap;
an advancement;
an x-height;
a cap height;
an italic angle;
a font type; and
a font-specific characteristic.

9. The user gesture recognition system of claim 1, wherein the input component and the output component comprise part of an application programming interface.

10. A computer-implemented method of gesture recognition, comprising:
receiving first information concerning content rendered to a user interface (UI) by an application and second information concerning a user gesture applied to the UI;
obtaining contextual features based on the first information and the second information;
identifying a gesture type for the user gesture from among a plurality of gesture types based on the contextual features; and
outputting the identified gesture type for the user gesture to the application.

11. The method of claim 10, further comprising:
obtaining shape features based on the second information and identifying one or more hypothetical gesture types for the user gesture based on the shape features;
wherein identifying the gesture type for the user gesture from among the plurality of gesture types comprises selecting one of the one or more hypothetical gestures types for the user gesture based on the contextual features.

12. The method of claim 10, wherein the content comprises one of:
gesture content;
text content;
shape content;
picture content;
mathematical symbol content; or
musical symbol content.

13. The method of claim 10, wherein the plurality of gesture types includes one or more of:
a strike-through;
a scratch-out;
a split;
a join;
an insertion;
a commit;
an overwrite; and
an addition of new content.

14. The method of claim 10, wherein the second information comprises information about one or more strokes made by a user.

15. The method of claim 10, wherein the first information includes one or more of:
an image that includes the content rendered to the UI;
a textual baseline;
a bounding box;
a word bounding rectangle;
a character bounding rectangle;
a spacing between characters;
a line height;
an ascent;
a descent;
a line gap;
an advancement;
an x-height;
a cap height;
an italic angle;
a font type; and
a font-specific characteristic.

16. A user gesture recognition system, comprising:
a memory that stores program logic; and
a processor operable to access the memory and to execute the program logic, the program logic comprising:
an input component that receives first information concerning content rendered to a user interface (UI) and second information concerning a user gesture applied to the UI;
a configuration manager that receives configuration information from the application and, based on the configuration information, identifies a plurality of eligible gesture types and at least one non-eligible gesture type from among a plurality of gesture types;
a context-aware gesture recognizer that obtains contextual features based on the first information and the second information and identifies a gesture type for the user gesture from among the plurality of eligible gesture types based on the contextual features; and
an output component that outputs the identified gesture type for the user gesture.

17. The user gesture recognition system of claim 16, wherein the program logic further comprises:
a context-free gesture recognizer that obtains shape features based on the second information and identifies one or more hypothetical gesture types for the user gesture from among the plurality of eligible gesture types based on the shape features;
wherein the context-aware gesture recognizer is configured to identify the gesture type for the user gesture from among the plurality of eligible gesture types by selecting one of the one or more hypothetical gestures types for the user gesture based on the contextual features.

18. The user gesture recognition system of claim 16, wherein the configuration information comprises a language.

19. The user gesture recognition system of claim 16, wherein the first information includes one or more of:
an image that includes the content rendered to the UI;
a textual baseline;
a bounding box;
a word bounding rectangle;
a character bounding rectangle;
a spacing between characters;
a line height;
an ascent;
a descent;
a line gap;
an advancement;
an x-height;
a cap height;
an italic angle;
a font type; and
a font-specific characteristic.

20. The user gesture recognition system of claim 16, wherein the plurality of gesture types includes one or more of:
a strike-through;
a scratch-out;
a split;
a join;
an insertion;
a commit;
an overwrite; and
an addition of new content.
